(19) United States
(12) Patent Application Publication
(10) Pub. No.: US 2022/0198599 A1
(43) Pub. Date: Jun. 23, 2022

(54) METHOD AND SYSTEM FOR PREFERENTIAL DISPATCH TO ORDERS WITH HIGH RISK

(71) Applicant: Beijing DiDi Infinity Technology and Development Co., Ltd., Beijing (CN)

(72) Inventors: Conghui FU, SANTA CLARA, CA (US); Zihan YI, MOUNTAIN VIEW, CA (US); Zetian NI, SUNNYVALE, CA (US); Xin CHEN, SUNNYVALE, CA (US)

(21) Appl. No.: 17/133,457

(22) Filed: Dec. 23, 2020

(51) Int. Cl. G06Q 50/30; G06Q 10/06; G06N 20/00

(52) U.S. Cl. CPC G06Q 50/30; G06Q 10/0635; G06Q 10/06315; G06Q 50/265; G06Q 10/06398; G06N 20/00; G06Q 10/063112

(57) ABSTRACT

Systems, methods, and non-transitory computer-readable media can receive a trip order and a driver pool, the driver pool comprising a plurality of drivers. A trip risk category selected among a plurality of trip risk categories can be assigned to the trip order. One or more dispatch rules learned from a trained dispatch machine learning model can be obtained. Based on the one or more dispatch rules, the driver pool can be filtered to obtain a qualified driver pool for the trip order. The qualified driver pool is fed to a dispatch engine which assigns a driver in the qualified driver pool to the trip order.

### TECHNICAL FIELD

The disclosure generally relates to system and methods for ridesharing, particularly, preferential dispatch to orders with high risk.

### BACKGROUND

Under traditional approaches, ridesharing platforms may connect passengers and drivers on relatively short notice. However, traditional ridesharing platforms suffer from a variety of safety and security risks for both passengers and drivers.

### SUMMARY

In one aspect of the present disclosure, in various implementations, a method may include receiving, by a computing system, a trip order and a driver pool, the driver pool comprising a plurality of drivers. The method may also include assigning, by the computing system, a trip risk category selected among a plurality of trip risk categories to the trip order. The method may further include obtaining, by the computing system, one or more dispatch rules learned from a trained dispatch machine learning model. The method may further include filtering, by the computing system, the driver pool to obtain a qualified driver pool for the trip order based on the one or more dispatch rules. The method may furthermore include feeding, by the computing system, the qualified driver pool to a dispatch engine, which assigns a driver in the qualified driver pool to the trip order.

In another aspect of the present disclosure, a computing system may comprise at least one processor and a memory storing instructions that, when executed by the at least one processor, cause the computing system to perform operations. The operations may include receiving, by a computing system, a trip order and a driver pool, the driver pool comprising a plurality of drivers. The operations may also include assigning, by the computing system, a trip risk category selected among a plurality of trip risk categories to the trip order. The operations may further include obtaining, by the computing system, one or more dispatch rules learned from a trained dispatch machine learning model. The operations may further include filtering, by the computing system, the driver pool to obtain a qualified driver pool for the trip order based on the one or more dispatch rules. The operations may furthermore include feeding, by the computing system, the qualified driver pool to a dispatch engine, which assigns a driver in the qualified driver pool to the trip order.

Yet another aspect of the present disclosure is directed to a non-transitory computer-readable storage medium including instructions that, when executed by at least one processor of a computing system, cause the computing system to perform operations. The operations may include receiving, by a computing system, a trip order and a driver pool, the driver pool comprising a plurality of drivers. The operations may also include assigning, by the computing system, a trip risk category selected among a plurality of trip risk categories to the trip order. The operations may further include obtaining, by the computing system, one or more dispatch rules learned from a trained dispatch machine learning model. The operations may further include filtering, by the computing system, the driver pool to obtain a qualified driver pool for the trip order based on the one or more dispatch rules. The operations may furthermore include feeding, by the computing system, the qualified driver pool to a dispatch engine, which assigns a driver in the qualified driver pool to the trip order.

In some embodiments, the trip order comprises a passenger of the trip order and information about the trip order. The driver pool further comprises a driver blacklist. A driver in the driver blacklist is excluded from the qualified driver pool.

In some embodiments, the method further comprises obtaining, by the computing system, passenger features associated with the passenger and trip order features extracted from the information about the trip order. The passenger features comprise at least one of: passenger gender, passenger age, passenger income, passenger history, passenger trip cancel rate, or comments about the passenger. The trip order features comprise at least one of: points of interest, a trip order time, a forecast trip duration, or third-party order information. The points of interest comprise at least one of: a pickup location or a drop off location. The third-party order information is a binary label indicating whether the trip order is placed by a third-party.

In some embodiments, the assigning the trip risk category is based on a trip risk score, that is determined using a trip-evaluation machine learning model based on the passenger features and the trip order features. The trip-evaluation machine learning model is a tree-based ensemble model.

In some embodiments, the dispatch machine learning model is a tree-based ensemble model.

In some embodiments, the one or more dispatch rules define a corresponding maximum driver risk score allowed for each of the plurality of trip risk categories.

In some embodiments, the filtering the driver pool to obtain the qualified driver pool for the trip order based on the one or more dispatch rules further comprises: determining, by the computing system, a first driver risk score for a first driver of the plurality of drivers using a driver-evaluation machine learning model based on driver features of the first driver; and in response to the first driver risk score being below a maximum driver risk score allowed for the trip risk category, selecting, by the computing system, the first driver to be included in the qualified driver pool.

In some embodiments, the driver features comprise at least one of: driver gender, driver age, driver rating, driver history, driver trip cancel rate, or comments about the driver. The driver-evaluation machine learning model is a linear regression model.

In some embodiments, the method further comprises training, by a computing system, the dispatch machine learning model based on a training dataset. The training further comprises: selecting, by the computing system, a plurality of training trips from historical trips; determining, by the computing system, a respective driver-score for each of the plurality of training trips using the driver-evaluation machine learning model based on respective driver features associated with the each of the plurality of training trips; determining, by the computing system, a respective trip risk category for the each of the plurality of training trips using the trip-evaluation machine learning model based on respective passenger features and respective trip order features associated with the each of the plurality of training trips; and generating, by the computing system, a training dataset based on the plurality of training trips, wherein data of each of the plurality of training trips comprises the respective driver-score, the respective trip risk category, a respective trip completion label indicating a completion or an abandonment of a trip order, and a respective trip outcome label indicating an occurrence or an absence of an incident.

In some embodiments, the selecting the plurality of training trips is further based on a control-variable sampling. The selecting the plurality of training trips further comprises: selecting, by the computing system, a first historical trip having an occurrence of an incident as a first training trip of the plurality of training trips; determining, by the computing system, a passenger and a driver, each associated with the first historical trip; determining, by the computing system, a first set of additional historical trips associated with the passenger; determining, by the computing system, a second set of additional historical trips associated with the driver; and selecting, by the computing system, one or more training trips of the plurality of training trips from at least one of: the first set of additional historical trips or the second set of additional historical trips.

These and other features of the methods, systems, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for a ridesharing platform system, in accordance with various embodiments of the disclosure.

FIG. 2 illustrates an example environment of a ridesharing platform system, in accordance with various embodiments of the disclosure.

FIG. 3 illustrates an example system diagram for dispatch intervention, in accordance with various embodiments of the disclosure.

FIG. 4 illustrates a flowchart of an example method for dispatch intervention, in accordance with various embodiments of the disclosure.

FIG. 5A illustrates a flowchart of an example method for training a dispatch machine learning model, in accordance with various embodiments of the disclosure.

FIG. 5B illustrates a flowchart of an example method for selecting training trips from historical trips, in accordance with various embodiments of the disclosure.

FIG. 6 illustrates a block diagram of an example computing system in which any of the embodiments described herein may be implemented.

### DETAILED DESCRIPTION

Specific, non-limiting embodiments of the present invention will now be described with reference to the drawings. It is to be understood that features and aspects of any embodiment disclosed herein may be used and/or combined with features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed within the spirit, scope and contemplation of the present invention as further defined in the appended claims.

The approaches disclosed herein may improve the passenger safety and security of a ridesharing service. A strong correlation exists between incidents with drivers being offenders and the passengers being victims and the drivers' behavior patterns on a ridesharing platform. As used herein, the incidents may be physical incidents (e.g., physical assaults, sexual harassment, and sexual abuses). For example, sexual harassment and abuse incidents may have a high occurrence rate in certain geographical regions. It is important for a ridesharing platform to intervene in dispatches related to orders with high risk by assigning more reliable drivers to vulnerable passengers or a protected group of passengers.

In various embodiments, the computer system can receive a trip order and a driver pool. The trip order comprises a passenger of the trip order and information about the trip order. The driver pool comprises a plurality of drivers and a driver blacklist. First, passenger features associated with the passenger and trip order features extracted from the information about the trip order can be obtained. A trip-risk score can be determined based on the passenger features and the trip order features using a trip-evaluation machine learning model (e.g., a tree-based ensemble model). Based on the trip risk score, a trip risk category selected among multiple trip risk categories can be assigned to the trip order. Then, a corresponding driver score can be determined for each driver in the driver pool based on corresponding driver features using a driver-evaluation machine learning model (e.g., a linear regression model). Further, based on the trip risk category and a driver score for a driver in the driver pool, one or more dispatch rules can be used to determine if the driver is qualified to be assigned to the trip order. Thereby the driver pool can be filtered to obtain a qualified driver pool for the trip order based on the one or more dispatch rules. A driver in the driver blacklist is excluded from the qualified driver pool. The dispatch rules can be predefined or generated from a trained dispatch machine learning model (e.g., a tree-based ensemble model). As an example, the dispatch rules can define a corresponding maximum driver risk score allowed for each trip risk category.

In various embodiments, both the trip-evaluation machine learning model and the dispatch machine learning model can be trained based on a set of training trips selected from historical trips. The set of training trips are selected based on a control-variable sampling method. For example, for a passenger and a driver identified from a historical trip having an occurrence of an incident, one or more historical trips associated with the identified passenger and/or the identified driver are selected as training trips.

In various embodiments, once the qualified driver pool is obtained, it is sent to a dispatch engine that matches a driver from the qualified driver pool with the trip order. The qualified driver pool has a reduced size and contains more reliable drivers. As a result, a dispatch intervention is achieved for the sake of improving passenger safety in a ridesharing service. The dispatch intervention process is not perceptible by either a passenger or a driver since there is no notification to either party. More details relating to the disclosed technology are provided below.

### Passenger, Driver, and Ridesharing Platform System

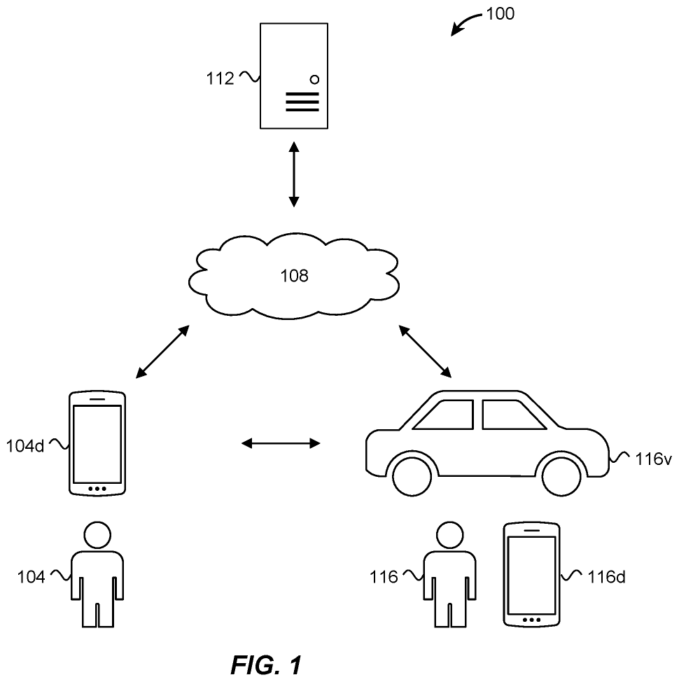

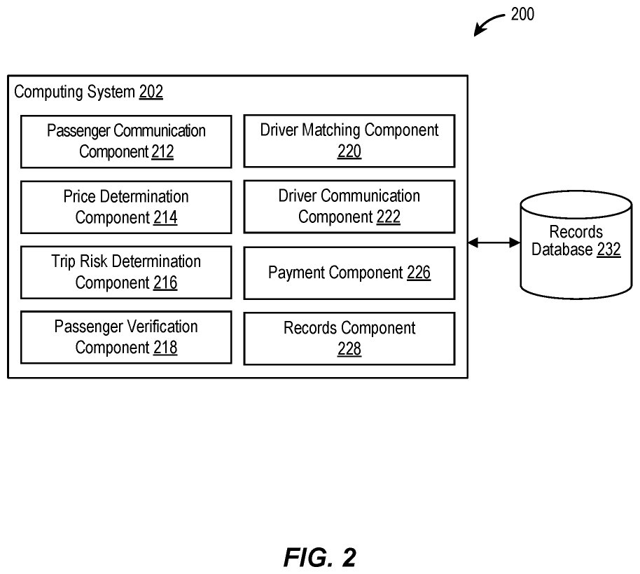

FIG. 1 illustrates an example environment for a ridesharing platform system. In the environment 100 illustrates in FIG. 1, a passenger 104 uses a passenger device 104d (e.g., a smartphone, a tablet, or a computer) to make a trip request, via a communication network 108 (e.g., the Internet) to a ridesharing platform system 112 (such as the computing system 200 described with reference to FIG. 2). The ridesharing platform system 112 can assign a driver 116 and the driver's vehicle 116v (e.g., a car, a SUV, and a truck) to fulfill the trip request. The driver 116 can receive and accept or decline the trip request using a driver device 116d (e.g., a smartphone, a tablet, or a computer). The driver device 116d can be a standalone device or part of the driver's vehicle 116v.

During an onboarding process, the passenger 104 and the driver 116 can provide personal information to the ridesharing platform system 112. Stringent background checks can increase driver safety and passenger safety. The passenger 104 can provide the ridesharing platform system 112 with a pickup or starting location and a drop off or destination location of a trip and receive pricing information (e.g., the estimated cost of the trip) and time information (e.g. the estimated duration of the trip). If the pricing information and time information are acceptable to the passenger 104, the passenger 104 can make a trip request or place an order (e.g., by clicking an order button) to the ridesharing platform system 112. After receiving the trip request from the passenger 104, the ridesharing platform system 112 can decide whether to accept the trip request and assign or match the driver 116 to the passenger for the trip request. Declining or rejecting a trip request of a passenger determined to be likely an offender in an incident can increase driver safety. The driver 116 can proceed to and arrive at the pickup location, where the passenger 104 can enter the driver's vehicle 116v and be transported, by the driver 116 using the vehicle 116v, to the drop off location of the trip request or order. The passenger 104 can pay (e.g., with cash or via the ridesharing platform system 112) the driver 116 after arrival at the drop off location.

Using the passenger device 104d, the passenger 104 can interact with the ridesharing platform system 112 and request ridesharing services. For example, the passenger 140, using the passenger device 104d, can make a trip request to the ridesharing platform system 112. A trip request can include rider identification information, the number of passengers for the trip, a requested type of the provider (e.g., a vehicle type or service option identifier), the pickup location (e.g., a user-specified location, or a current location of the passenger device 104d as determined using, for example, a global positioning system (GPS) receiver), and/or the destination for the trip.

The passenger device 104d can interact with the ridesharing platform system 112 through a client application configured to interact with the ridesharing platform system 112. The client application can present information, using a user interface, received from the ridesharing platform system 112 and transmit information to the ridesharing platform system 112. The information presented on the user interface can include driver-related information, such as driver identity, driver vehicle information, driver vehicle location, and driver estimated arrival. The information presented on the user interface can include the drop off location, a route from the pickup location to the drop off location, an estimated trip duration, an estimated trip cost, and current traffic condition. The passenger device 104d can include a location sensor, such as a global positioning system (GPS) receiver, that can determine the current location of the passenger device 104d. The user interface presented by the client application can include the current location of the passenger device 104. The information transmitted can include a trip request, a pickup location, and a drop off location.

The ridesharing platform system 112 can allow the passenger 104 to specify parameters for the trip specified in the trip request, such as a vehicle type, a pick-up location, a trip destination, a target trip price, and/or a departure timeframe for the trip. The ridesharing platform system 112 can determine whether to accept or reject the trip request and, if so, assign or attempt to assign the driver 116 with the driver vehicle 116v and the driver device 116d to the passenger 104 and the passenger's trip request. For example, the ridesharing platform system 112 can receive a trip request from the passenger device 104d, select a driver from a pool of available drivers to provide the trip, and transmit an assignment request to the selected driver's device 116d.

The driver 116 can interact with, via the driver device 116d, the ridesharing platform system 112 to receive an assignment request to fulfill the trip request. The driver can decide to start receiving assignment requests by going online (e.g., launching a driver application and/or providing input on the driver application to indicate that the driver is receiving assignments), and stop receiving assignment requests by going offline. The driver 116 can receive, from the ridesharing platform system 112, an assignment request to fulfill a trip request made by the passenger using the passenger device 104d to the ridesharing platform system 112. The driver 116 can, using the driver device 116d, accept or reject the assignment request. By accepting the assignment request, the driver 116 and the driver's vehicle 116v are assigned to the particular trip of the passenger 104 and are provided the passenger's pickup location and trip destination.

The driver device 116d can interact with the ridesharing platform system 112 through a client application configured to interact with the ridesharing platform system 112. The client application can present information, using a user interface, received from the ridesharing platform system 112 (e.g., an assignment request, a pickup location, a drop off location, a route from the pickup location to the drop off location, an estimated trip duration, current traffic condition, and passenger-related information, such as passenger name and gender) and transmit information to the ridesharing platform system 112 (e.g., an acceptance of an assignment request). The driver device 116d can include a location sensor, such as a global positioning system (GPS) receiver, that can determine the current location of the driver device 116d. The user interface presented by the client application can include the current location of the driver device 116 and a route from the current location of the driver device 116 to the pickup location. After accepting the assignment, the driver 116, using the driver's vehicle 116v, can proceed to the pickup location of the trip request to pick up the passenger 104.

The passenger device 104d and the driver device 116d can communicate with the ridesharing platform system 112 via the network 108 can include one or more local area and wide area networks employing wired and/or wireless communication technologies (e.g., 3G, 4G, and 5G), one or more communication protocols (e.g., transmission control protocol/Internet protocol (TCP/IP) and hypertext transport protocol (HTTP)), and one or more formats (e.g., hypertext markup language (HTML) and extensible markup language (XML).

### Trip Risk Evaluation

FIG. 2 illustrates an example environment 200 for a ridesharing platform system, in accordance with various embodiments. The example environment 200 may include a ridesharing computing system 202. The computing system 202 may include one or more processors and memory (e.g., permanent memory, temporary memory). The processor(s) may be configured to perform various operations by interpreting machine-readable instructions stored in the memory. The computing system 202 may include other computing resources. The computing system 202 may have access (e.g., via one or more connections, via one or more networks) to other computing resources.

The computing system 202 may include a passenger communication component 212, a price determination component 214, a trip risk determination component 216, a passenger verification component 218, a driver matching component 220, a driver communication component 224, a payment component 226, and a trip records component 228. The computing system 202 may include other components. While the computing system 202 is shown in FIG. 2 as a single entity, this is merely for ease of reference and is not meant to be limiting. One or more components or one or more functionalities of the computing system 202 described herein may be implemented in software. One or more components or one or more functionalities of the computing system 202 described herein may be implemented in hardware. One or more components or one or more functionalities of the computing system 202 described herein may be implemented in a single computing device or multiple computing devices. In some embodiments, one or more components or one or more functionalities of the computing system 202 described herein may be implemented in one or more networks (e.g., enterprise networks), one or more endpoints, one or more servers, or one or more clouds.

A passenger, such as the passenger 104 described with reference to FIG. 1 (or a passenger's device, such as the passenger device 104 described with reference to FIG. 1) can communicate with the ridesharing computing system 202 via the passenger communication component 212. For example, during the trip request process, the passenger can provide personal information to the ridesharing computing system 202 via the passenger communication component 212. For example, the passenger can provide the ridesharing computing system 202, via the passenger communication component 212, with a pickup location and a drop off location of a trip. For example, the passenger communication component 212 can provide the passenger with pricing information of the trip (e.g., the estimated cost of the trip) and time information of the trip (e.g. the estimated duration of the trip). If the pricing information and time information are acceptable to the passenger, the passenger can make a trip request or place an order (e.g., by clicking an order button) to the ridesharing computing system 202, via the passenger communication component 212. After receiving the trip request from the passenger, the ridesharing computing system 202 can determine whether to accept or decline the trip request or order based on a risk of the trip determined by the risk determination component 216. The risk determination component 216 can determine the risk of the trip using the verification information provided by the passenger and the validity of the verification information determined by the passenger verification component 218. If the risk is acceptable (e.g., below a threshold level), the ridesharing computing system 202 can assign or match the driver to the passenger for the particular trip request using the driver matching component 220. The ridesharing computing system 202, using the driver communication component 224, can provide the assigned driver with an assignment of the trip request. The ridesharing computing system 202, using the driver communication component 224, can receive the driver's acceptance of the assignment of the trip request. The driver communication component 224 can provide the driver with information relating to the progress of the trip, such as the driver's distances from the pickup location and drop off location and a route from the pickup location to the drop off location. The ridesharing computing system 202, using the payment component 226, can receive the passenger's payment for the trip. The records component 228 can store information related to the trip (e.g., the driver information) in the records database 232. The records database 232 can also store the passenger information and the driver information (e.g., received during the registration process, such as the passenger's name, or trip request process).

In determining the risk of a trip, the trip risk determination component 216 may acquire, analyze, determine, examine, identify, load, locate, obtain, open, receive, retrieve, and/or review driver and passenger information. The trip risk determination component 216 may access the driver and passenger information from one or more locations. For example, the risk determination component 216 may access driver and passenger information from a storage location, such as an electronic storage 232 of the computing system 202, an electronic storage of a device accessible via a network, another computing device/system (e.g., desktop, laptop, smartphone, tablet, mobile device), or other locations.

A driver who plans an incident with respect to a passenger may have shown certain behavior patterns. For example, a driver may cancel several trip requests until the driver finds a target passenger. For example, a criminal may tend to target a particular passenger gender. After a passenger makes a request for a trip, whether the trip is risky can be determined by the trip risk determination component 216.

In order to reduce the number of driver-led incidents, a dispatch intervention in the driver matching component 220 can be carried out for orders with high risk by assigning reliable drivers to vulnerable passengers or a protected group of passengers.

### Dispatch Intervention System

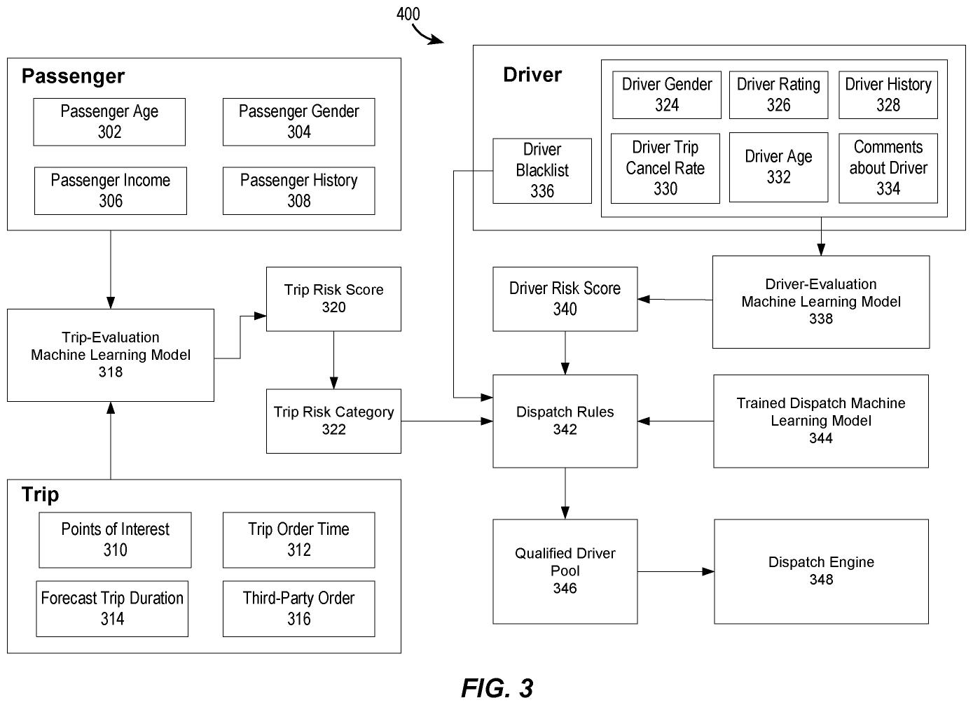

FIG. 3 illustrates an example system diagram for dispatch intervention, in accordance with various embodiments of the disclosure.

In some embodiments, passenger features include a passenger age 302, a passenger gender 304, a passenger income 306, and a passenger history 308. The passenger features can also include passenger trip cancel rate and comments/ratings/feedbacks about the passenger. The passenger history 308 can include data associated with the passenger's historical trips.

The passenger gender 304 can be determined based on the passenger's name. A system and method of determining a passenger's gender based on the passenger's name is disclosed in U.S. patent application Ser. No. 16/435,157, filed on Jun. 7, 2019 and entitled “ANALYZING PASSENGER GENDER ON A RIDESHARING PLATFORM”, which is incorporated herein by reference in its entirety.

The passenger income 306 can be determined based on a passenger's residential address. A system and method of determining a passenger's income based on the passenger's residential address is disclosed in U.S. patent application Ser. No. 16/435,106, filed on Jun. 7, 2019 and entitled “ESTIMATING PASSENGER INCOME LEVEL ON A RIDESHARING PLATFORM”, which is incorporated herein by reference in its entirety.

In some embodiments, the passenger features can also be obtained based on other information of the passenger including credit card information, a national ID etc. that are provided by third-party services.

In some embodiments, trip order features include points of interest 310, a trip order time 312, a forecast trip duration 314, and third-party order information 316.

Points of interest 310 (POIs) can include a pickup location and a drop off location. Different POIs 310 can be associated with different risk levels. The risk level of POIs can be adjusted based on the trip order time 312 and the forecast trip duration 314. For example, based on historical data and/or public data, the pickup location or the drop off location at or near a nightclub or a bar during a specific time window may be determined as unsafe.

The third-party order information 316 is a binary label indicating whether an order is placed by a third-party. Third-party order 316 can be determined based on a distance between the third-party and a pickup location, a messenger log between the third-party and the ridesharing platform, and a trajectory of a computing device of the third-party. If a trip is ordered by the third-party, the passenger information may be unknown to the ridesharing platform. Out of an abundance of caution, the passenger may be assumed to belong to a protected passenger group when the trip is ordered by the third-party.

In some embodiments, a trip-evaluation machine learning model 318 takes input data comprising at least one of: the passenger age 302, the passenger gender 304, the passenger income 306, the passenger history 308, the points of interest 310, the trip order time 312, the forecast trip duration 314, or the third-party order 316. The trip-evaluation machine learning model 318 generates a trip risk score 320 as an output.

The trip-evaluation machine learning model 318 may be any type of machine learning models. In some embodiments, the trip-evaluation machine learning model 318 is a tree-based ensemble model such as Random Forest, Extremely Randomized Trees, Adaptive Boosting, Gradient Boosting, etc.

If the trip risk score 320 falls within a pre-defined score range corresponding to a trip risk category 322 among a plurality of trip risk categories, the trip risk category 322 is assigned to the trip order. Different trip risk categories correspond to different risk levels of trip orders.

In some embodiments, driver features include a driver gender 324, a driver rating 326, a driver history 328, a driver trip cancel rate 330, a driver age 332, and comments about driver 334. The driver history 328 includes historical trips serviced by the driver. The driver trip cancel rate 330 is a ratio between a number of trips canceled by the driver and a total number of trips assigned to the driver within a period of time. The comments about driver 334 are reviews by passengers to whom the driver has provided transportation services.

The comments about driver 334 can be used to capture negative driver behaviors. A system and method of capturing negative driver behaviors based on passenger comments is disclosed in U.S. patent application Ser. No. 16/718,036, filed on Dec. 17, 2019 and entitled “COMMENT-BASED BEHAVIOR PREDICTION”, which is incorporated herein by reference in its entirety.

In some embodiments, a driver blacklist 336 can include drivers having incident history and drivers who have conducted negative behaviors based on passengers' comments.

In some embodiments, a driver-evaluation machine learning model 338 takes the driver features of a driver in an original driver pool as input and generates a driver risk score 340 as output. The driver-evaluation machine learning model 338 may be any type of machine learning models, e.g., a linear regression model.

In some embodiments, dispatch rules 342 take the trip risk category 322, the driver risk score 340, and the driver blacklist 336 as input, and output a decision whether the driver with the driver risk score 340 is qualified to be assigned to the trip order with the trip risk category 322. If the driver is qualified, the driver is added to the qualified driver pool 346, which is a subset of the original driver pool. Then, the qualified driver pool 346 instead of the original driver pool is sent to a dispatch engine 348, which assigns a driver in the qualified driver pool to the trip order

In some embodiments, a trained dispatch machine learning model 344 can produce the dispatch rules 342 that define a corresponding maximum driver risk score allowed for each of the plurality of trip risk categories.

The dispatch machine learning model 344 may be any type of machine learning models. In some embodiments, the trip-evaluation machine learning model dispatch is a tree-based ensemble model such as Random Forest, Extremely Randomized Trees, Adaptive Boosting, Gradient Boosting, etc.

Table 1 below depicts example trip risk categories. As an example, a trip order can be classified into one of nine risk categories such as R0, R1, . . . , and R8, using a trip-evaluation machine learning model based on passenger features and trip order features including passenger age, passenger income, trip order time, and forecast trip duration time. The different trip risk categories correspond to different risk levels. For example, a trip ordered at nighttime for a drunk young woman with low income is classified as R0, i.e., a category having the highest risk. In Table 1, from R0, R1, to R8, corresponding trip risks gradually decrease. In Table 1, two trip orders are assigned to a same trip risk category R2. One is a trip order with medium to long trip duration ordered at nighttime for a young woman with low to moderate income. Another one is a trip order with medium trip duration ordered at late night for a young woman, are assigned to a same trip risk category R2. The trip risk categories listed in Table 1 are examples. Many variations are possible.

TABLE 1

| | Trip Order | Forecast Trip | Passenger | Passenger | |
|---|---|---|---|---|---|
| Rule | Time | Duration | Income | Age | Description |
| R0 | 22 <= x <= 7 | | <=1.5 | <=30 | nighttime, drunk young women, low |
| | | | | | income |
| R1 | 22 <= x <= 5 | >=16 | <=1 | <=30 | late night, young women, long trip |
| | | | | | duration |
| R2 | 22 <= x <= 7 | >=10 | <=1.2 | <=30 | nighttime, young women, low to moderate |
| | | | | | income, medium to long trip duration |
| R2 | 22 <= x <= 5 | 10 <= x <= 16 | <=1.3 | <=30 | late night, young women, medium trip |
| | | | | | duration |
| R3 | 22 <= x <= 5 | 5 <= x < 10 | <=1.5 | <=30 | late night, young women, short to |
| | | | | | medium trip duration |
| R4 | 19 <= x <= 21 | >16 | | <=30 | evening after work, young women, long |
| | | | | | trip duration |
| R5 | 19 <= x <= 21 | 7 <= x <= 16 | <=1.5 | <=35 | evening after work, relatively young |
| | | | | | women, medium to long trip duration |
| R6 | 7 < x <= 18 | >=10 | <2 | <40 | daytime, relatively young women, middle |
| | | | | | income, medium to long trip duration |
| R7 | 7 < x <= 18 | <10 | <=3 | <=40 | daytime, relatively young women, low to |
| | | | | | medium trip duration |
| R8 | 19 <= x <= 7 | | | <55 | nighttime, non-elderly women |

Table 2 below depicts example dispatch rules extracted from a trained dispatch machine learning model. The dispatch rules define a corresponding maximum driver risk score allowed for each trip risk category. That is, for a trip risk category, any driver with a driver risk score below the corresponding maximum driver risk score is a qualified driver. If a driver is in blacklist L10, the driver is immediately disqualified for trip orders of any trip risk categories.

In Table 2, a driver can be classified to one of ten driver risk categories such as L0, L1, . . . , and L9, based on the driver risk score determined using a driver-evaluation machine learning model based on driver features. For example, if a driver risk score is below 0.05, the driver is classified as L0. If a driver risk score falls within (0.05, 0.06], the driver is classified as L1, and so forth. If a driver risk score is above 0.43, the driver is classified as L9.

Further, in Table 2, for example, for a trip order with trip risk category R0, the maximum driver risk score allowed is 0.05, thereby drivers with driver risk scores below 0.05 are qualified drivers for the trip order. That is, all drivers in driver risk categories L0 are qualified drivers for the trip order with trip risk category R0. As another example, for a trip order with trip risk category R2, the maximum driver risk score allowed is 0.08, thus drivers with driver risk scores below 0.08 are qualified drivers for the trip order. That is, all drivers in driver risk categories L0, L1, and L2 are qualified drivers for the trip order with trip risk category R2. In yet another example, for a trip order with trip risk category R9, the maximum driver risk score allowed is 0.43, thus drivers with driver risk scores below 0.43 are qualified drivers for the trip order. That is, all drivers in driver risk categories L0, L1, . . . , and L8 are qualified drivers for the trip order of trip risk category R9. In yet another example, for a trip order of trip risk category R9, no maximum driver risk score is set, thus all drivers with any driver risk scores are qualified drivers for the trip order. That is, all drivers in all driver risk categories L0, L1, . . . , and L9 are qualified drivers for the trip order of trip risk category R9, except drivers in the blacklist (L10).

Furthermore, in Table 2, among the trip risk categories R0, R1, . . . , and R9, R0 has the lowest allowed maximum driver risk score. The allowed maximum driver risk scores gradually increase as the trip risk categories goes from R0, R1, until R9, which has the highest allowed maximum driver risk score. Therefore, drivers who are qualified for a trip risk category are also qualified for all other trip risk categories with lower risk. For example, drivers who are qualified for R0 that has the highest risk are also qualified for all the other trip categories, i.e., R1, R2, . . . , and R9. Conversely, drivers who are not qualified for a trip risk category are also not qualified for all other trip risk categories with higher risk. For example, drivers who are not qualified for R9 are also not qualified for all the other trip categories, i.e., R8, R7, . . . , and R0.

In Table 2, a cell value “Y” (Yes) or “N” (No) indicates whether a driver with a risk score falling in the range of a corresponding column (e.g., L0, L1, . . . , or L9) is qualified for a trip order of a trip risk category (e.g., R0, R1, . . . , or R9) in a corresponding row. A driver in the blacklist (L10) is not qualified for any trip risk categories. The dispatch rules illustrated in Table 2 are examples. Many variations are possible.

TABLE 2

| | L0 | L1 | L2 | L3 | L4 | L5 | L6 | L7 | L8 | L9 | L10 |
|---|---|---|---|---|---|---|---|---|---|---|---|
| | [0, | (0.05, | (0.06, | (0.08, | (0.085, | (0.09, | (0.19, | (0.2, | (0.415, | (0.43 | (black- |
| | 0.05] | 0.06] | 0.08] | 0.085] | 0.09] | 0.19] | 0.2] | 0.415] | 0.43] | +) | list) |
| R0: nighttime, | Y | N | N | N | N | N | N | N | N | N | N |
| drunk young | | | | | | | | | | | |
| women, low | | | | | | | | | | | |
| income | | | | | | | | | | | |
| R1: late night, | Y | Y | N | N | N | N | N | N | N | N | N |
| young women, | | | | | | | | | | | |
| long trip | | | | | | | | | | | |
| duration | | | | | | | | | | | |
| R2: nighttime, | Y | Y | Y | N | N | N | N | N | N | N | N |
| young women, | | | | | | | | | | | |
| low to | | | | | | | | | | | |
| moderate | | | | | | | | | | | |
| income, | | | | | | | | | | | |
| medium to long | | | | | | | | | | | |
| trip duration | | | | | | | | | | | |
| R2: late night, | Y | Y | Y | N | N | N | N | N | N | N | N |
| young women, | | | | | | | | | | | |
| medium trip | | | | | | | | | | | |
| duration | | | | | | | | | | | |
| R3: late night, | Y | Y | Y | Y | N | N | N | N | N | N | N |
| young women, | | | | | | | | | | | |
| short to | | | | | | | | | | | |
| medium trip | | | | | | | | | | | |
| duration | | | | | | | | | | | |
| R4: evening | Y | Y | Y | Y | Y | N | N | N | N | N | N |
| after work, | | | | | | | | | | | |
| young women, | | | | | | | | | | | |
| long trip | | | | | | | | | | | |
| duration | | | | | | | | | | | |
| R5: evening | Y | Y | Y | Y | Y | Y | N | N | N | N | N |
| after work, | | | | | | | | | | | |
| relatively | | | | | | | | | | | |
| young women, | | | | | | | | | | | |
| medium to long | | | | | | | | | | | |
| trip duration | | | | | | | | | | | |
| R6: daytime, | Y | Y | Y | Y | Y | Y | Y | N | N | N | N |
| relatively | | | | | | | | | | | |
| young women, | | | | | | | | | | | |
| middle income, | | | | | | | | | | | |
| medium to long | | | | | | | | | | | |
| trip duration | | | | | | | | | | | |
| R7: daytime, | Y | Y | Y | Y | Y | Y | Y | Y | N | N | N |
| relatively | | | | | | | | | | | |
| young women, | | | | | | | | | | | |
| low to medium | | | | | | | | | | | |
| trip duration | | | | | | | | | | | |
| R8: nighttime, | Y | Y | Y | Y | Y | Y | Y | Y | Y | N | N |
| non-elderly | | | | | | | | | | | |
| women | | | | | | | | | | | |
| R9: Other | Y | Y | Y | Y | Y | Y | Y | Y | Y | Y | N |
| women | | | | | | | | | | | |

### Dispatch Intervention Method

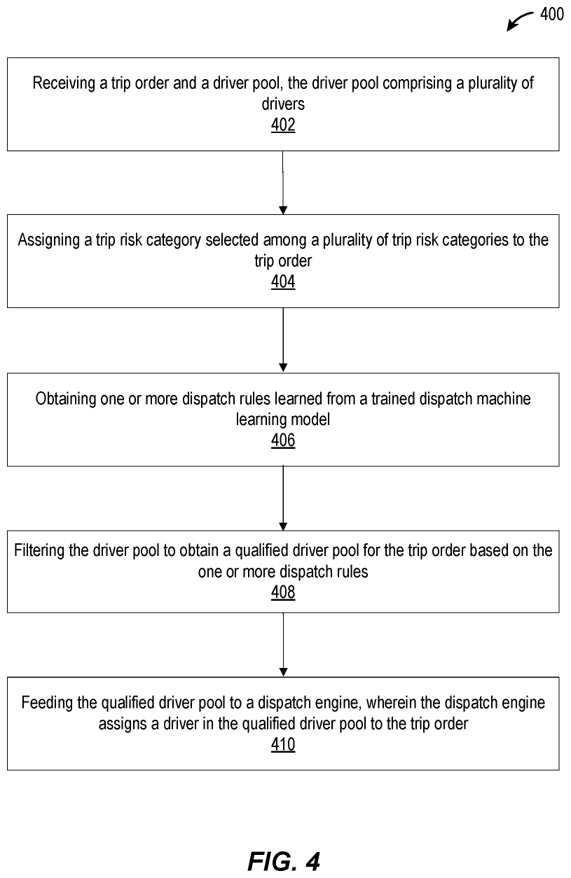

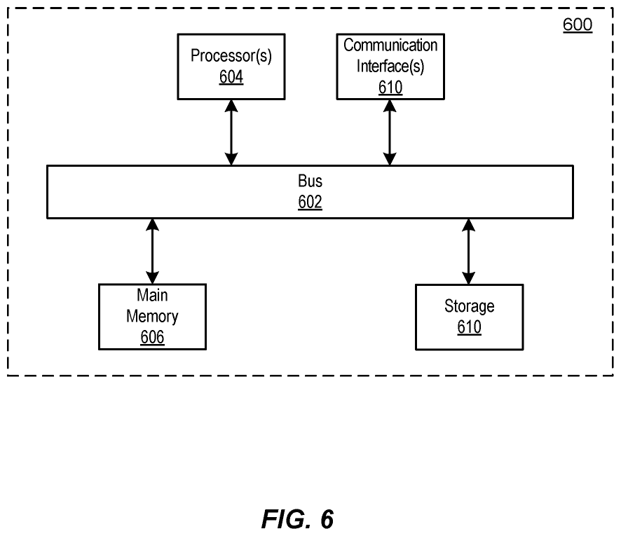

FIG. 4 illustrates a flowchart of an example method 400 for dispatch intervention, according to various embodiments of the present disclosure. The method 400 can be implemented in various environments including, for example, the environment 200 of FIG. 2 and by computer systems, such as the computer system 202 of FIG. 2, or the computer system 600 of FIG. 6. The operations of the method 400 presented below are intended to be illustrative. Depending on the implementation, the method 400 can include additional, fewer, or alternative steps performed in various orders or in parallel. The method 400 can be implemented in various computing systems or devices including one or more processors.

With respect to the method 400, at block 402, a computing system (such as the computer system 202 of FIG. 2, or the computer system 600 of FIG. 6) can receive a trip order and a driver pool. The driver pool comprises a plurality of drivers.

With respect to the method 400, at block 404, the computing system can assign a trip risk category selected among a plurality of trip risk categories to the trip order.

With respect to the method 400, at block 406, the computing system can obtain one or more dispatch rules learned from a trained dispatch machine learning model.

With respect to the method 400, at block 408, the computing system can filter the driver pool to obtain a qualified driver pool for the trip order based on the one or more dispatch rules.

With respect to the method 400, at block 410, the computing system can feed the qualified driver pool to a dispatch engine, which can assign a driver in the qualified driver pool to the trip order.

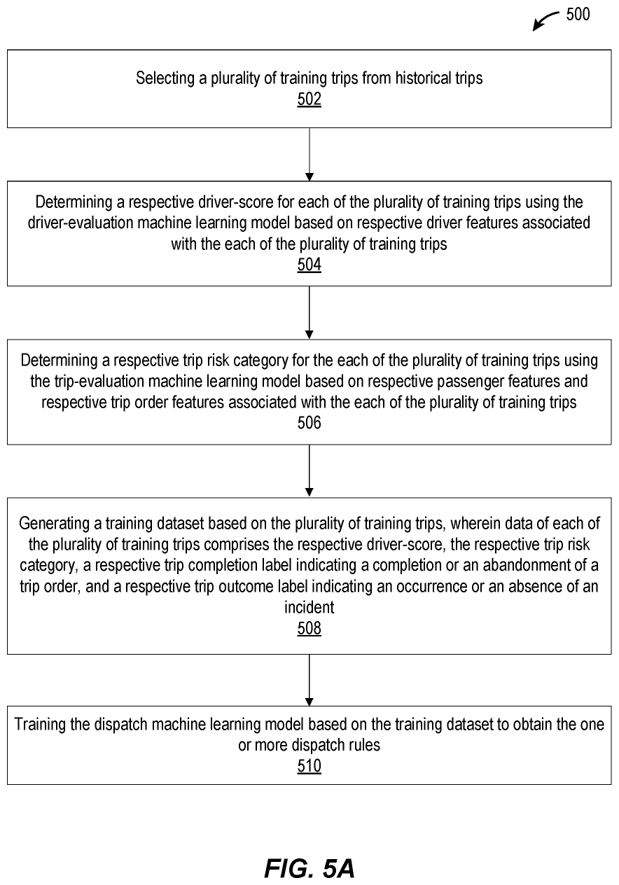

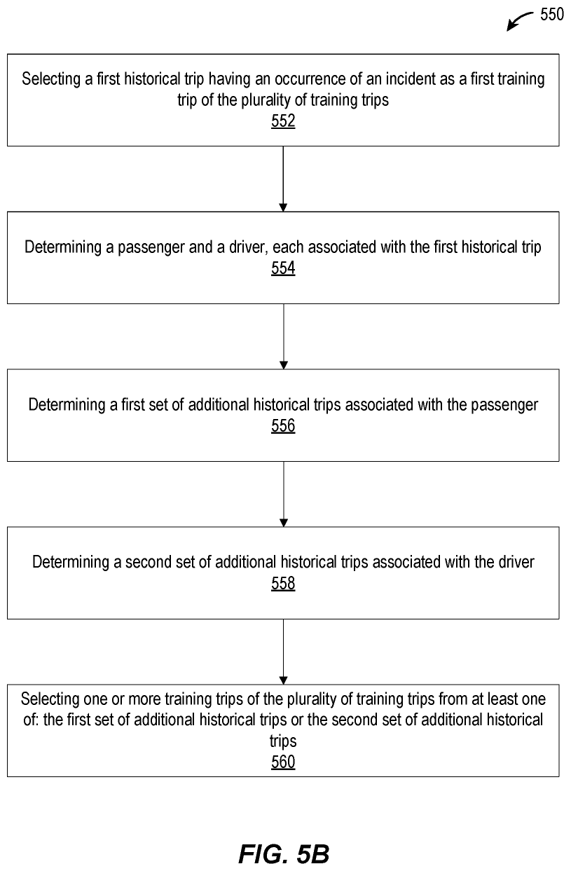

FIG. 5A illustrates a flowchart of an example method 500 for training the dispatch machine learning model, according to various embodiments of the present disclosure. The method 500 can be implemented in the same environments as the method 400.

With respect to the method 500, at block 502, the computing system can select a plurality of training trips from historical trips. Since there are only a few problematic orders (e.g., orders with incidents) for a time period, the ratio of cases with incidents and cases without incidents is extremely small. Thus, data associated with the trip orders is extremely imbalanced. The dispatch machine learning model needs be trained to produce rules to filter out drivers associated with the few problematic orders from millions of normal orders without falsely filtering out too many good drivers. In order to train the dispatch machine learning model efficiently, the training dataset can be generated from the original dataset of millions of orders using sampling methods such as query by bagging (e.g., under sampling on cases without incidents), selective sampling (e.g., taking samples with similar distributions), oversampling on cases with incidents, control-variable sampling, etc. In some embodiments, a control-variable sampling method is used to select a set of training trips from historical trips. For example, for a passenger and a driver identified from a historical trip having an occurrence of an incident, one or more historical trips associated with the identified passenger and/or the identified driver are selected as training trips. The control-variable sampling method is depicted in FIG. 5B.

With respect to the method 500, at block 504, the computing system can determine a respective driver-score for each of the plurality of training trips using the driver-evaluation machine learning model based on respective driver features associated with each of the plurality of training trips.

With respect to the method 500, at block 506, the computing system can determine a respective trip risk category for the each of the plurality of training trips using the trip-evaluation machine learning model based on respective passenger features and respective trip order features associated with the each of the plurality of training trips.

With respect to the method 500, at block 508, the computing system can generate a training dataset based on the plurality of training trips. Data of each of the plurality of training trips comprises the respective driver-score, the respective trip risk category, a respective trip completion label, and a respective trip outcome label. The trip completion label indicates a completion or an abandonment of a trip order. The respective trip outcome label indicates an occurrence or an absence of an incident.

With respect to the method 500, at block 510, the computing system can train the dispatch machine learning model based on the training dataset to obtain the one or more dispatch rules.

FIG. 5B illustrates a flowchart of an example method 550 for selecting a plurality of training trips from historical trips based on a control-variable sampling, according to various embodiments of the present disclosure. The method 550 can be implemented in the same environments as the method 400.

With respect to the method 550, at block 552, the computing system can select a first historical trip having an occurrence of an incident as a first training trip of the plurality of training trips.

With respect to the method 550, at block 554, the computing system can select a passenger and a driver, each associated with the first historical trip.

With respect to the method 550, at block 556, the computing system can determine a first set of additional historical trips associated with the passenger.

With respect to the method 550, at block 558, the computing system can determine a second set of additional historical trips associated with the driver.

With respect to the method 550, at block 560, the computing system can select one or more training trips of the plurality of training trips from the first set of additional historical trips and/or the second set of additional historical trips.

### Computer System

FIG. 6 is a block diagram that illustrates a computer system 600 upon which any of the embodiments described herein may be implemented. The computer system 600 includes a bus 602 or other communication mechanisms for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache and/or other dynamic storage devices, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, render computer system 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 608. Execution of the sequences of instructions contained in main memory 606 causes processor(s) 604 to perform the process steps described herein. For example, the process/method shown in FIGS. 5A-5B and described in connection with this figure may be implemented by computer program instructions stored in main memory 606. When these instructions are executed by processor(s) 604, they may perform the steps as shown in FIGS. 5A-5B and described above. In alternative embodiments, hard-wired circuitry may be used in place of or in combination with software instructions.

The computer system 600 also includes a communication interface 610 coupled to bus 602. Communication interface 610 provides a two-way data communication coupling to one or more network links that are connected to one or more networks. As another example, communication interface 610 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 202 may be described as performing or configured for performing an operation, when the components may comprise instructions which may program or configure the computing system 202 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are equivalent in meaning and be open ended in that an item or items following any of these words is not meant to be an exhaustive listing of such item or items, or meant to be limited to only the listed item or items. It must also be noted that as used herein and in the appended claims, the singular forms “a,” “an,” and “the” include plural references unless the context dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method, comprising:
receiving, by a computing system, a trip order and a driver pool, the driver pool comprising a plurality of drivers;
assigning, by the computing system, a trip risk category selected among a plurality of trip risk categories to the trip order;
obtaining, by the computing system, one or more dispatch rules learned from a trained dispatch machine learning model;
filtering, by the computing system, the driver pool to obtain a qualified driver pool for the trip order based on the one or more dispatch rules; and
feeding, by the computing system, the qualified driver pool to a dispatch engine, wherein the dispatch engine assigns a driver in the qualified driver pool to the trip order.

2. The computer-implemented method of claim 1, wherein:
the trip order comprises a passenger of the trip order and information about the trip order; and
the driver pool further comprises a driver blacklist, wherein a driver in the driver blacklist is excluded from the qualified driver pool.

3. The computer-implemented method of claim 1, further comprising:
obtaining, by the computing system, passenger features associated with the passenger and trip order features extracted from the information about the trip order.

4. The computer-implemented method of claim 3, wherein the passenger features comprise at least one of: passenger gender, passenger age, passenger income, passenger history, passenger trip cancel rate, or comments about the passenger.

5. The computer-implemented method of claim 3, wherein the trip order features comprise at least one of: points of interest, a trip order time, a forecast trip duration, or third-party order information, wherein:
the points of interest comprise at least one of: a pickup location or a drop off location, and
the third-party order information is a binary label indicating whether the trip order is placed by a third-party.

6. The computer-implemented method of claim 1, wherein the assigning the trip risk category is based on a trip risk score, wherein the trip risk score is determined using a trip-evaluation machine learning model based on the passenger features and the trip order features.

7. The computer-implemented method of claim 1, wherein the trip-evaluation machine learning model is a tree-based ensemble model.

8. The computer-implemented method of claim 1, wherein the dispatch machine learning model is a tree-based ensemble model.

9. The computer-implemented method of claim 1, wherein the one or more dispatch rules define a corresponding maximum driver risk score allowed for each of the plurality of trip risk categories.

10. The computer-implemented method of claim 1, wherein the filtering the driver pool to obtain the qualified driver pool for the trip order based on the one or more dispatch rules further comprises:
determining, by the computing system, a first driver risk score for a first driver of the plurality of drivers using a driver-evaluation machine learning model based on driver features of the first driver; and
in response to the first driver risk score being below a maximum driver risk score allowed for the trip risk category,
selecting, by the computing system, the first driver to be included in the qualified driver pool.

11. The computer-implemented method of claim 1, wherein the driver features comprise at least one of: driver gender, driver age, driver rating, driver history, driver trip cancel rate, or comments about the driver.

12. The computer-implemented method of claim 1, wherein the driver-evaluation machine learning model is a linear regression model.

13. The computer-implemented method of claim 1, further comprising:
training, by a computing system, the dispatch machine learning model based on a training dataset, wherein the training further comprises:
selecting, by the computing system, a plurality of training trips from historical trips;
determining, by the computing system, a respective driver-score for each of the plurality of training trips using the driver-evaluation machine learning model based on respective driver features associated with the each of the plurality of training trips;
determining, by the computing system, a respective trip risk category for the each of the plurality of training trips using the trip-evaluation machine learning model based on respective passenger features and respective trip order features associated with the each of the plurality of training trips; and
generating, by the computing system, a training dataset based on the plurality of training trips, wherein data of each of the plurality of training trips comprises the respective driver-score, the respective trip risk category, a respective trip completion label indicating a completion or an abandonment of a trip order, and a respective trip outcome label indicating an occurrence or an absence of an incident.

14. The computer-implemented method of claim 13, wherein the selecting the plurality of training trips is further based on a control-variable sampling, and the selecting the plurality of training trips further comprises:
selecting, by the computing system, a first historical trip having an occurrence of an incident as a first training trip of the plurality of training trips;
determining, by the computing system, a passenger and a driver, each associated with the first historical trip;
determining, by the computing system, a first set of additional historical trips associated with the passenger;
determining, by the computing system, a second set of additional historical trips associated with the driver; and
selecting, by the computing system, one or more training trips of the plurality of training trips from at least one of: the first set of additional historical trips or the second set of additional historical trips.

15. A system comprising:
at least one processor; and
a memory storing instructions that, when executed by the at least one processor, cause the system to perform operations comprising:
receiving a trip order and a driver pool, the driver pool comprising a plurality of drivers;
assigning a trip risk category selected among a plurality of trip risk categories to the trip order;
obtaining one or more dispatch rules learned from a trained dispatch machine learning model;
filtering the driver pool to obtain a qualified driver pool for the trip order based on the one or more dispatch rules; and
feeding the qualified driver pool to a dispatch engine, wherein the dispatch engine assigns a driver in the qualified driver pool to the trip order.

16. The system of claim 15, wherein the one or more dispatch rules define a corresponding maximum driver risk score allowed for each of the plurality of trip risk categories.

17. The system of claim 15, wherein the filtering the driver pool to obtain the qualified driver pool for the trip order based on the one or more dispatch rules further comprises:
determining a first driver risk score for a first driver of the plurality of drivers using a driver-evaluation machine learning model based on driver features of the first driver; and
in response to the first driver risk score being below a maximum driver risk score allowed for the trip risk category, selecting the first driver to be included in the qualified driver pool.

18. A non-transitory computer-readable storage medium including instructions that, when executed by at least one processor of a computing system, cause the computing system to perform operations comprising:
receiving a trip order and a driver pool, the driver pool comprising a plurality of drivers;
assigning a trip risk category selected among a plurality of trip risk categories to the trip order;
obtaining one or more dispatch rules learned from a trained dispatch machine learning model;
filtering the driver pool to obtain a qualified driver pool for the trip order based on the one or more dispatch rules; and
feeding the qualified driver pool to a dispatch engine, wherein the dispatch engine assigns a driver in the qualified driver pool to the trip order.

19. The non-transitory computer-readable storage medium of claim 18, wherein the one or more dispatch rules define a corresponding maximum driver risk score allowed for each of the plurality of trip risk categories.

20. The non-transitory computer-readable storage medium of claim 18, wherein the filtering the driver pool to obtain the qualified driver pool for the trip order based on the one or more dispatch rules further comprises:
determining a first driver risk score for a first driver of the plurality of drivers using a driver-evaluation machine learning model based on driver features of the first driver; and
in response to the first driver risk score being below a maximum driver risk score allowed for the trip risk category, selecting the first driver to be included in the qualified driver pool.
